(19) United States
(12) Patent Application Publication
(10) Pub. No.: US 2003/0136125 A1
(43) Pub. Date: Jul. 24, 2003

(54) Load-settable rapid lifting jack

(75) Inventor: Victor Hung, Lu Chu Hsiang (TW)

Correspondence Address: BACON & THOMAS, PLLC, 625 SLATERS LANE, FOURTH FLOOR, ALEXANDRIA, VA, 22314

(73) Assignee: SHINN FU CORPORATION, Lu Chu Hsiang (TW)

(21) Appl. No.: 10/052,272

(22) Filed: Jan. 23, 2002

(51) Int. Cl. F16D 31/02

(52) U.S. Cl. 60/479

(57) ABSTRACT

A load-settable rapid lifting jack comprises a switching oil cylinder between a pump oil chamber and an inner oil tank. A little and limited hydraulic oil in the pump oil chamber is utilized to push a switching piston as the hydraulic oil flows into the switching oil cylinder; and a larger amount of hydraulic oil is provided to the inner oil tank of the jack so that the jack lifting spindle is lifted rapidly in a predetermined load. Moreover, when the load is over a rated value, a sequential valve can be opened rapidly so as to restore to a general lifted speed.

### BACKGROUND OF THE INVENTION

(a) Field of the Invention

The present invention relates to jacks, and particularly to load-settable rapid lifting jack, wherein a switching oil cylinder is used so that the jack lifting spindle can be lifted rapidly within a predetermined load.

(b) Description of the Prior Art

Prior hydraulic oil jack with or without loads must be lifted slowly by shaking a handle repeatedly. Thus, it is time and labor consumed. Therefore, U.S. patent Ser. Nos. 09/146,432 and 09/766,620 assigned to the inventor of the present invention discloses a hydraulic oil jack with a rapid lifted arm. In that, the inner hydraulic oil circuit is changed so that the jack can be lifted rapidly in an idle condition.

Furthermore, the inventor of the present invention discloses a “manually rapidly lifted hydraulic oil jack in idle condition”, U.S. patent Ser. No. 09/912,529. In the prior art, the arm of the jack contacts and is combined with the handle. As a result, an arm can be lifted rapidly in idle condition.

However, above prior art designs still have some defects necessary to be improved since in heavy load, the jack is still lifted slowly.

### SUMMARY OF THE INVENTION

Accordingly, the primary object of the present invention is to provide a load-settable rapid lifting jack comprising a switching oil cylinder between a pump oil chamber and an inner oil tank. A little and limited hydraulic oil in the pump oil chamber is utilized to push a switching piston as the hydraulic oil flows into the switching oil cylinder; and a larger amount of hydraulic oil is provided to the inner oil tank of the jack so that the jack lifting spindle is lifted rapidly in a predetermined load. Moreover, when the load is over a rated value, a sequential valve can be opened rapidly so as to restore to a general lifted speed.

The various objects and advantages of the present invention will be more readily understood from the following detailed description when read in conjunction with the appended drawing.

### BRIEF DESCRIPTION OF THE DRAWINGS

FIG. 1 is a schematic perspective view of the jack base of the present invention.

FIG. 2 is an exploded perspective view of the jack base of the present invention.

FIG. 3 is a schematic perspective view of the oil circuit of the present invention.

FIG. 4 is a schematic cross sectional view showing part of the oil circuit of the present invention.

FIG. 5 is a schematic cross sectional view of the jack base of the present invention.

FIG. 6 is a schematic view showing the operation of the switching piston of the present invention.

### DETAILED DESCRIPTION OF THE PREFERRED EMBODIMENTS

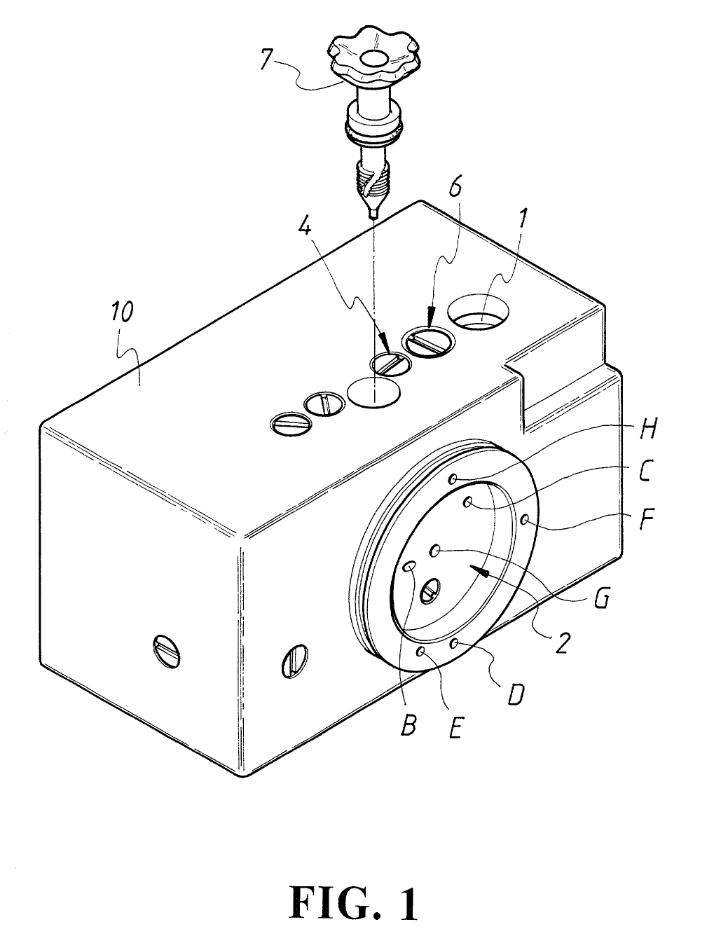

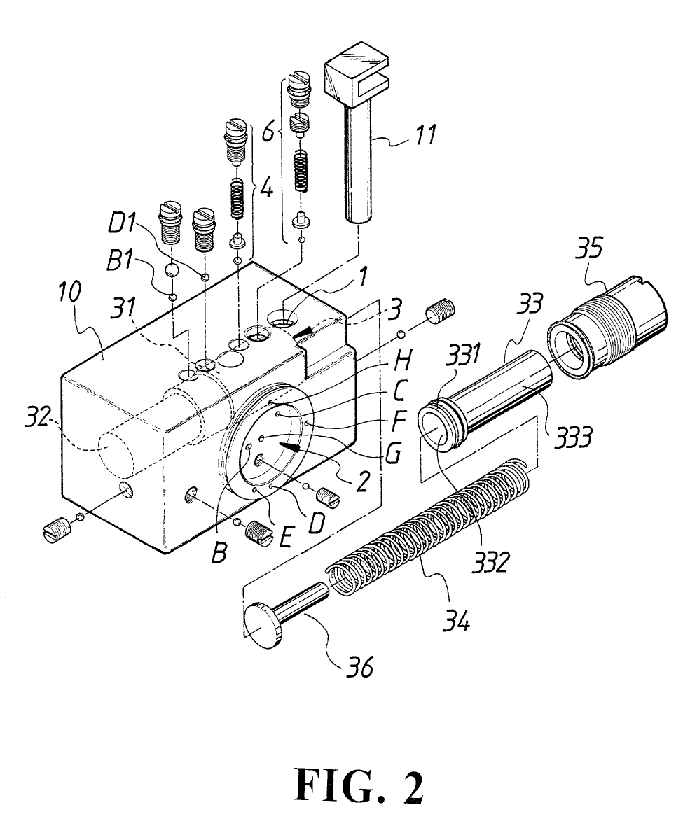

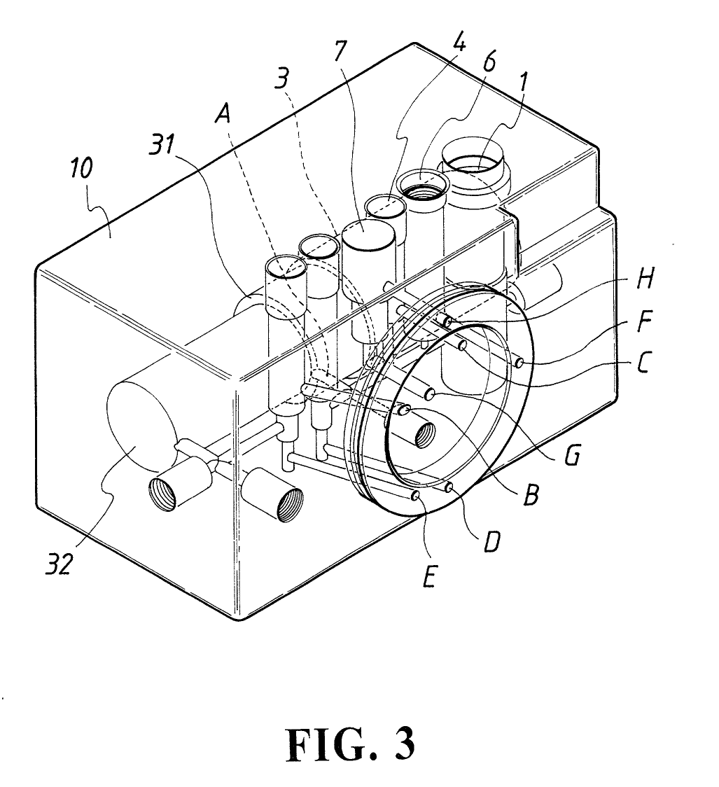

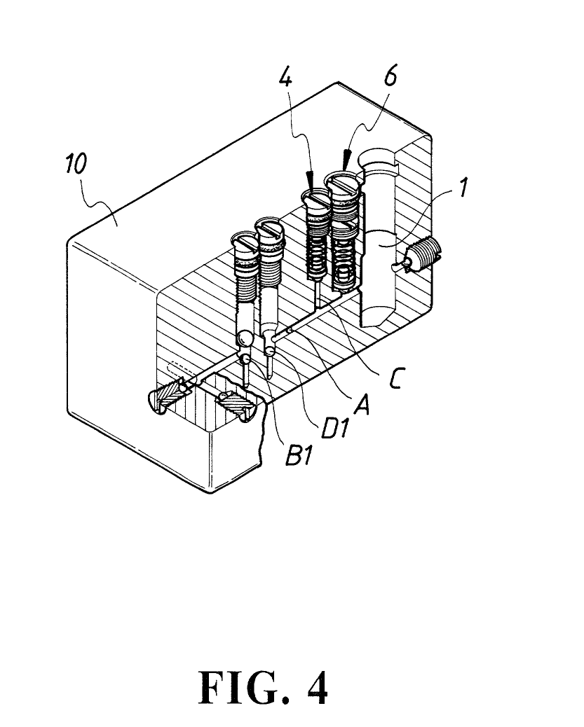

Referring to FIGS. 1 and 2, the load-settable rapid lifting jack of the present invention is illustrated. In the present invention, a switching oil cylinder 33 with a rated load is installed between the pump oil chamber 1 and the oil tank 2 of the hydraulic jack base 10. The switching oil cylinder 3 has a rod cavity 31 and a rodless cavity 32 and a switching piston 33 is installed therein. The rod cavity 31 of the switching oil cylinder 3 has an oil channel A at a predetermined position adjacent to the piston head 331 (referring to FIG. 3) and has an oil channel B at a predetermined position of the rodless cavity 32. The oil channel B is installed with a check valve B1 (referring to FIG. 4) so that the hydraulic oil only transfers to the inner oil tank 2 unidirectionally. Thereby, when the piston 11 is manipulated, then as the little and finite hydraulic oil in the pump oil chamber 1 enters into the rod cavity 3 of the switching oil cylinder 3, the switching piston 33 will be pushed and the more hydraulic oil in the rodless cavity 32 of the switching oil cylinder 3 enters into the inner oil tank 2 in the jack so that the spindle of the jack can be lifted rapidly in a setting load.

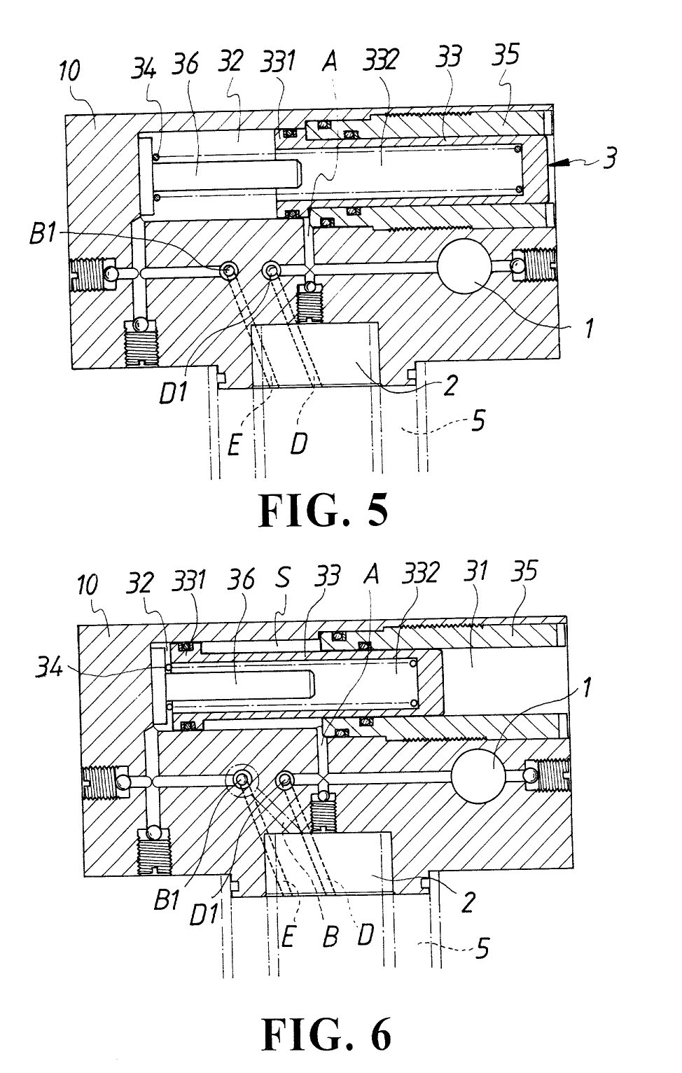

With reference to FIGS. 3 and 4, in above mentioned pump oil chamber 1, other than the oil channel A communicated to the rod cavity 31 of the switching oil cylinder 3, a further oil channel C communicated to the inner oil tank 2 is installed and the oil channel C has a sequential valve 4. Therefore, when the inner pressure of the switching oil cylinder 3 achieves to a rated load so as to stop the operation, then the sequential valve 4 can be opened so that the hydraulic oil flows through the oil channel C and the sequential valve 4 to the inner oil tank 2. As a result, the lift spindle of the jack can restore to the general low and steady lifting speed, as shown in FIGS. 5 and 6. The switching oil cylinder 3 is installed at a predetermined side of the jack base 10. At least one switching oil cylinder 3 and elastic resilient element 34 are installed in the oil cylinder. Then it may be used with a retaining nut 35 and then is locked to one end of the rod cavity 32. The elastic resilient element 34 resists against the inner wall at the bottom of the switching oil cylinder 3, while another end resists against the switching piston 33 so as to elastically restore the switching oil cylinder 3. The elastic resilient element 34 is a compressible spring or a telescopic spring 33 so as to restore the switching piston 33, or may be other selected elastic elements.

Above switching oil cylinder 3 may be further installed with a guide rod 36 at an inner wall of the bottom for positioning the elastic resilient element 34. The switching oil cylinder 3 may have a hollow inner chamber 332, thereby, the rod cavity 31 may insert into the hollow inner chamber 332 so as to have a preferred contact by resisting thereon. When it is operated, the switching piston 33 has no interference with the guide rod 36.

By above components, when the piston starts, the hydraulic oil is absorbed to the pump oil chamber 1 from the outer oil tank 5 of the jack through the oil channel D and then passes through the oil channel A to the rod cavity 31 of the switching oil cylinder 3 so that the little hydraulic oil in the pump oil chamber 1 pushes the switching piston 33 to displace the piston as the hydraulic oil flows into the switching oil cylinder 3. Thereby, the more hydraulic oil in the rodless cavity 32 of the switching oil cylinder 3 can flow into the inner oil tank 2 of the jack directly. Thereby, the lifting spindle of the jack can be lifted rapidly as a predetermined load. Besides, a check valve D1 is installed in the oil channel D for preventing hydraulic oil to flow back to the outer oil tank 5. During flowing back, the switching oil cylinder 3 may complete the operation of supplying oil from another oil channel E which is communicated to the outer oil tank 5. That is, when the pump piston finishes the operation of restoring and prepares for the next operation, the inner pressure of the rod cavity 31 becomes small, and thus the switching piston 33 may be resist against by the elastic resilient element 34 so as to restore to the original place. Therefore, the rodless cavity 33 completes the operation of supplying oil from the oil channel E, and prepares for the next operation for supplying oil.

When the inner pressure of the rodless cavity 33 of the switching oil cylinder 3 is over a rated inner pressure, since the inner pressure of the switching oil cylinder 3 is too large, the switching oil cylinder 3 stops to input oil from the oil channel A. Then, the sequential valve 4 actuates automatically. As a result, the succeeding operation of sucking oil of the pump piston will execute the oil channel C and then the sequential valve 4 is opened. Then oil flows into the inner oil tank 2. Then, the lifting spindle of the jack is lifted steadily and slowly as in the normal operation.

With reference to FIGS. 5 and 6, the traveling length of the switching piston 33 is mainly determined by the size of the hydraulic oil containing space S around the switching piston 33. The containing space S of the hydraulic oil is adjustable according to the ratio of the circumferences of the piston head 331 of the switching piston 33 and the piston body 333. In other words, the larger the circumference of the piston body 333, the smaller the containing space S of the hydraulic oil. The longer the traveling length of the switching piston 33, the more the oil flowing into the inner oil tank 2. Thus, the lifting length of the lifting spindle of the jack is longer. On the contrary, the shorter the circumference of the piston body 333, the larger the containing space S of the hydraulic oil. The shorter the traveling length of the switching piston 33, the little the oil flowing into the inner oil tank 2. Thus, the lifting length of the lifting spindle of the jack is shorter.

By above components of the load-settable rapid lifting jack of the present invention, the predetermined side of the jack base 10 is installed with a safety valve 6. The safety valve 6 is installed between the pump oil chamber 1 and the outer oil tank 5 and has a safety oil returning channel F. When the jack lifting spindle travels to the end of the traveling (the distal tube wall of the inner oil tank 2 is not installed with oil returning trench or device) or the load is over the rated inner pressure of the inner oil tank 2. The hydraulic oil will cause the safety valve 6 to be opened, so that the hydraulic oil can be drained to the outer oil tank 5 from the pump oil chamber 1 through the oil channel F so that the hydraulic oil is circulated between the inner oil tank 2 and the outer oil tank 5, has no more effect to the jack lifting spindle. Therefore, the jack lifting spindle only remains in the original position without being lifted, and thus no danger due to overpressure or of explosion occurs.

Other than above assembling way, in the present invention, the predetermined side of the jack base 10 may be installed with a safety relief valve 7. The safety relief valve 7 is installed between the oil channel G connected to the inner oil tank 2 and the oil channel H of the outer oil tank 5. When the safety relief valve 7 is opened, the oil in the inner oil tank 2 will return to the outer oil tank 5 through the oil channels G and H. Therefore, the jack lifting spindle descends gradually to the original position.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A load-settable rapid lifting jack comprising a switching oil cylinder between a pump oil chamber and an inner oil tank; wherein little and limited hydraulic oil in the pump oil chamber is utilized to push a switching piston as the hydraulic oil flows into the switching oil cylinder; and a larger amount of hydraulic oil is provided to the inner oil tank of the jack so that the jack lifting spindle is lifted rapidly in a predetermined load.

2. The load-settable rapid lifting jack as claimed in claim 1, wherein a rod cavity of the switching oil cylinder is formed with an oil channel at a predetermined position adjacent to the piston head, and is formed with another oil channel communicated to the inner oil tank and at a predetermined position of a rodless cavity.

3. The load-settable rapid lifting jack as claimed in claim 2, wherein the switching oil cylinder is installed with a check valve in the oil channel of the rod cavity communicated to the inner oil tank.

4. The load-settable rapid lifting jack as claimed in claim 1, wherein the pump oil chamber is further installed with an oil channel communicated to the inner oil tank and is installed with a sequential valve in the oil channel; as the inner pressure of the switching oil cylinder achieves to a rated value, the sequential valve is opened so that the hydraulic oil flows into the inner oil tank through the oil channel and the sequential valve.

5. The load-settable rapid lifting jack as claimed in claim 1, wherein the switching oil cylinder is installed at a predetermined side of the jack base and at least one switching oil cylinder and an elastic resilient element are installed within the oil cylinder, wherein the switching oil cylinder is movably installed in the lower inner wall of the switching oil cylinder, and another end thereof resists against the switching oil cylinder.

6. The load-settable rapid lifting jack as claimed in claim 5, wherein the switching piston is movably locked to one end of the rod cavity of the switching oil cylinder by a retaining nut.

7. The load-settable rapid lifting jack as claimed in claim 5, wherein the elastic resilient element is a compressible spring or a telescopic spring.

8. The load-settable rapid lifting jack as claimed in claim 5, wherein a guide rod is installed at a lower inner wall of the switching oil cylinder for positioning the elastic resilient element.

9. The load-settable rapid lifting jack as claimed in claim 5, wherein the switching oil cylinder has a hollow inner chamber, thereby, the elastic resilient element can be inserted into the hollow inner chamber to resist against the wall of the inner chamber.

10. The load-settable rapid lifting jack as claimed in claim 1, wherein an oil channel is installed between the pump oil chamber and the outer oil tank of the jack, and a check valve for preventing hydraulic oil from returning is installed in the oil channel.

11. The load-settable rapid lifting jack as claimed in claim 1, wherein the switching oil cylinder is installed with an oil channel communicated to the outer oil tank for supplying oil to the returning path of the rodless cavity of the switching oil cylinder.

12. The load-settable rapid lifting jack as claimed in claim 1, wherein a length of the switching oil cylinder is determined by the size of the hydraulic oil containing space around the switching piston.

13. The load-settable rapid lifting jack as claimed in claim 12, wherein a length of the switching oil cylinder is determined by the size of the hydraulic oil containing space around the switching oil cylinder, and the size of the hydraulic oil containing space is determined by the ratio of the piston head of the switching piston and the circumference of the piston body, and is adjustable.

14. The load-settable rapid lifting jack as claimed in claim 1, wherein a safety valve is installed at a predetermined side of a jack base and the safety valve is installed between the pump oil chamber and the outer oil tank, and a safety oil returning path is formed.

15. The load-settable rapid lifting jack as claimed in claim 1, wherein a safety relief valve is installed at a predetermined side of a jack base, and the safety relief valve is connected between an oil channel connected to the inner oil tank and an oil channel connected to the outer oil tank.
